(19) United States
(12) Patent Application Publication
(10) Pub. No.: US 2009/0044554 A1
(43) Pub. Date: Feb. 19, 2009

(54) SHUT-OFF VALVE SUPPORT MEMBER AND OUTDOOR UNIT OF AIR CONDITIONER PROVIDED WITH THE SAME

(75) Inventors: Hisashi Takeichi, Osaka (JP); Naohiro Kawasaki, Osaka (JP)

Correspondence Address: GLOBAL IP COUNSELORS, LLP, 1233 20TH STREET, NW, SUITE 700, WASHINGTON, DC, 20036-2680, US

(73) Assignee: DAIKIN INDUSTRIES, LTD., Osaka-shi, Osaka (JP)

(21) Appl. No.: 12/090,399

(22) PCT Filed: Oct. 26, 2006
(86) PCT No.: PCT/JP2006/321433

§ 371 Date: Apr. 16, 2008

(30) Foreign Application Priority Data
Oct. 31, 2005 (JP) 2005-315997

(51) Int. Cl. F25D 23/00; F16K 27/00

(52) U.S. Cl. 62/259.1; 251/366

(57) ABSTRACT

In a plate shaped shut-off valve support member configured to support a shut-off valve to which a refrigerant pipe on an indoor unit side is connected, and configured to be extended across a first fixing portion and a second fixing portion of an outdoor unit, the operability of a service port of the shut-off valve is ensured and the strength of the shut-off valve support member is improved. A shut-off valve support member (30) comprises an attachment portion (35), an interference prevention portion (36), and a stepped portion (37). A shut-off valve (61, 62) is attached to the attachment portion (35) with a service port (61a, 62a) of the shut-off valve (61, 62) protruding in a direction perpendicular to a longitudinal direction of the shut-off valve support member. The interference prevention portion (36) is located at a position opposite to the attachment portion (35) when viewed in the longitudinal direction, away from the service port (61a, 62a) in a thickness direction of the shut-off valve support member, and is disposed so as to overlap with the service port (61a, 62a) when viewed in the thickness direction. The stepped portion (37) is formed between the attachment portion (35) and the interference prevention portion (36).

### TECHNICAL FIELD

The present invention relates to a shut-off valve support member and an outdoor unit of an air conditioner provided with the same. More specifically, the present invention relates to a shut-off valve support member having a plate shape, configured to support a shut-off valve to which a refrigerant pipe on an indoor unit side is connected, and arranged to be extended across a first fixing portion and a second fixing portion of the outdoor unit; and relates to an outdoor unit of an air conditioner provided with the same.

### BACKGROUND ART

As a conventional outdoor unit of an air conditioner, there is known an outdoor unit having a structure in which the inside of a casing having a generally rectangular parallelepiped box shape is divided into a fan chamber and a machine chamber by a partition plate extending vertically. The inside of this fan chamber mainly includes an outdoor heat exchanger and an outdoor fan. In addition, the machine chamber mainly includes a compressor disposed therein. In addition, the outdoor unit is provided with a liquid side shut-off valve and a gas side shut-off valve to each of which a refrigerant pipe on an indoor unit side is connected. As this type of outdoor unit, there is an outdoor unit having a plate shaped shut-off valve support member provided so as to be extended between a front plate of a casing or a partition plate and a side plate of the casing, and the liquid side shut-off valve and the gas side shut-off valve are supported by this shut-off valve support member. Thereby, this type of outdoor unit has a structure in which these shut-off valves are disposed in the machine chamber (see patent document 1).

Patent Document 1

Japanese Patent Application Publication No. H03-36443

### DISCLOSURE OF THE INVENTION

With this type of shut-off valve support member, the shut-off valve support member may be deformed when working on the shut-off valves on site (for example, opening and closing of a service port) due to the bending load that acts on the shut-off valve support member, therefore the shut-off valve support member is configured to have a large plate width in order to ensure the strength thereof. However, this causes a problem creating interference between the shut-off valve support member and the service port of the shut-off valve, which consequently impairs the operability of the shut-off valve.

An object of the present invention is, in a plate shaped shut-off valve support member supporting a shut-off valve to which a refrigerant pipe on an indoor unit side is connected and being extended across a first fixing portion and a second fixing portion of an outdoor unit, to ensure the operability of a service port of the shut-off valve and improve the strength of the shut-off valve support member.

A shut-off valve support member according to a first aspect of the present invention is a shut-off valve support member having a plate shape, configured to support a shut-off valve to which a refrigerant pipe on an indoor unit side is connected, and arranged to be extended across a first fixing portion and a second fixing portion of an outdoor unit, the shut-off valve support member comprising an attachment portion, an interference prevention portion, and a stepped portion. The attachment portion is a portion to which the shut-off valve is attached, with a service port of the shut-off valve protruding in a direction perpendicular to a longitudinal direction of the shut-off valve support member. The interference prevention portion is located opposite to the attachment portion when viewed in the longitudinal direction, away from the service port in a thickness direction of the shut-off valve support member, and is disposed so as to overlap with the service port when viewed in the thickness direction. The stepped portion is formed between the attachment portion and the interference prevention portion.

The interference prevention portion and the stepped portion that connects between the interference prevention portion and attachment portion are formed on this shut-off valve support member, thus preventing interference between the shut-off valve support member and the service port of the shut-off valve and increasing the section modulus of the shut-off valve support member. Accordingly, it is possible to ensure the operability of the service port of the shut-off valve and improve the strength of the shut-off valve support member.

A shut-off valve support member according to a second aspect of the present invention is the shut-off valve support member according to the first aspect of the present invention, wherein the interference prevention portion and the stepped portion are formed so as to be continuous across both side portions of the shut-off valve in the longitudinal direction.

The interference prevention portion and the stepped portion are formed on this shut-off valve support member so as to be continuous across the both side portions of the shut-off valve in the longitudinal direction, thus further improving the operability of the service port of the shut-off valve and the strength of the shut-off valve support member.

A shut-off valve support member according to a third aspect of the present invention is the shut-off valve support member according to the first or the second aspect of the present invention, wherein the attachment portion is a portion to which a liquid side shut-off valve and a gas side shut-off valve each as the shut-off valve are attached side by side in the longitudinal direction. The interference prevention portion and the stepped portion are formed so as to be continuous with each other between the liquid side shut-off valve and the gas side shut-off valve in the longitudinal direction, when viewed in the thickness direction.

With this shut-off valve support member, the interference prevention portion and the stepped portion are formed to as to be continuous with each other between the liquid side shut-off valve and the gas side shut-off valve in the longitudinal direction when viewed in the thickness direction, thus improving the strength of the shut-off valve support member.

A shut-off valve support member according to a fourth aspect of the present invention is the shut-off valve support member according to any one of the first to the third aspects of the present invention, wherein the shut-off valve support member has a groove portion formed therein, which extends in the longitudinal direction so as to overlap with at least a portion of the shut-off valve when viewed in the thickness direction and which is recessed in the thickness direction.

This shut-off valve support member has the groove portion formed therein, which extends in the longitudinal direction so as to at least partially overlap with the shut-off valve when viewed in the thickness direction, thus further improving the strength of the shut-off valve support member.

An outdoor unit of an air conditioner according to a fifth aspect of the present invention, comprising a casing having a generally rectangular parallelepiped box shape, a partition plate extending vertically so as to divide the inside of the casing, a shut-off valve support member according to any one of the first to the fifth aspects of the present invention, and a shut-off valve to which a refrigerant pipe on an indoor unit side is connected. The shut-off valve support member is extended between a first fixing portion formed on the partition plate or on a surface of the casing near the partition plate and a second fixing portion formed on a surface of the casing, the surface facing the partition plate. The shut-off valve is supported by the shut-off valve support member.

This outdoor unit of the air conditioner comprises the shut-off valve support member according to any one of the first to the fifth aspects of the present invention, thus ensuring the operability of the service port of the shut-off valve and improving the strength of the shut-off valve support member.

### BRIEF DESCRIPTION OF THE DRAWINGS

FIG. 1 is a plan view of an outdoor unit in which an embodiment of a shut-off valve support member according to the present invention (shown with a top plate and refrigerant circuit components other than a compressor, an outdoor heat exchanger, and shut-off valves removed) is adopted.

FIG. 2 is an elevation view of the outdoor unit (with left and right front plates and refrigerant circuit components other than the compressor, the outdoor heat exchanger, and the shut-off valves removed).

FIG. 3 is a view showing a liquid side shut-off valve and a gas side shut-off valve.

FIG. 4 is a perspective view showing the shut-off valve support member.

FIG. 5 is a view taken in a direction of arrow M of FIG. 4.

FIG. 6 is a sectional view taken along line N-N of FIG. 5.

### DESCRIPTION OF THE REFERENCE SYMBOLS

1 outdoor unit
2 unit casing (casing)
28 partition plate
30 shut-off valve support member
35 attachment portion
36 interference prevention portion
37 stepped portion
38b, 38c groove portion
61 liquid side shut-off valve
62 gas side shut-off valve
61a, 62a service port

### BEST MODE FOR CARRYING OUT THE INVENTION

An embodiment of a shut-off valve support member and an outdoor unit of an air conditioner provided with the same according to the present invention is now described with reference to the drawings.

### (1) Entire Structure of the Outdoor Unit

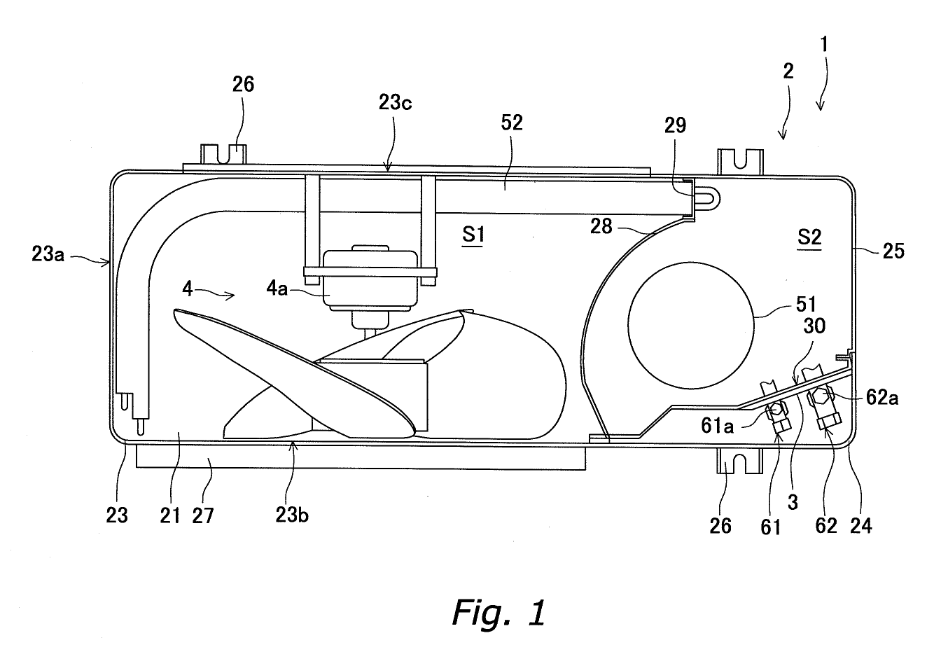

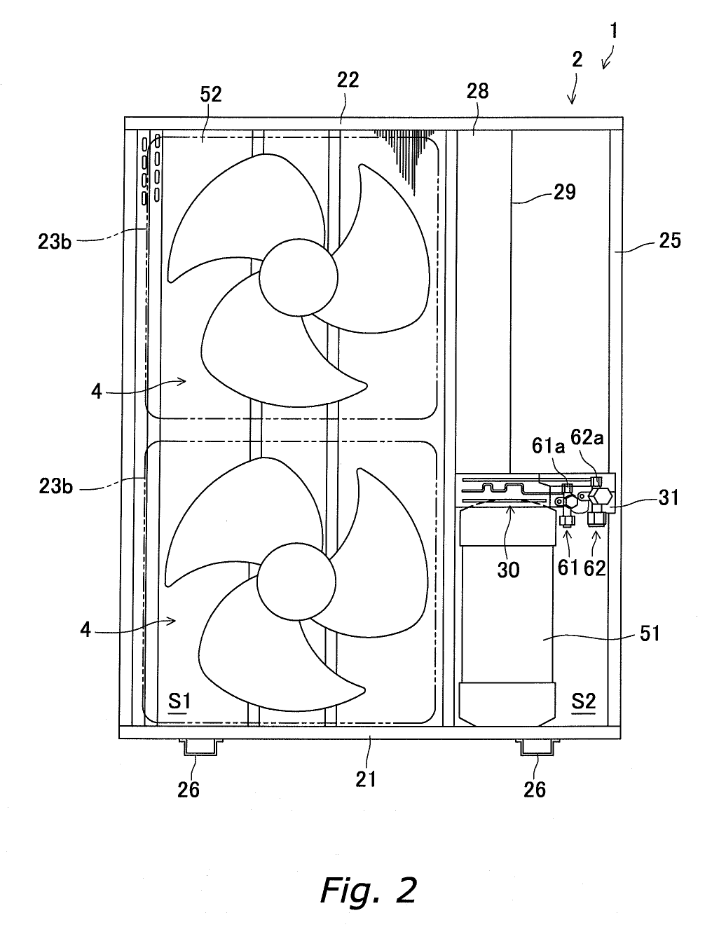

FIG. 1 a plan view of an outdoor unit 1 in which an embodiment of the shut-off valve support member according to the present invention (shown with a top plate 22 and refrigerant circuit components 5 other than a compressor 51, an outdoor heat exchanger 52, and shut-off valves 61, 62 removed) is adopted. In addition, FIG. 2 is an elevation view of the outdoor unit 1 (with left and right front plates 23, 24, and the refrigerant circuit components 5 other than the compressor 51, the outdoor heat exchanger 52, and the shut-off valves 61, 62 removed).

This outdoor unit 1 is installed outside, and has a so-called trunk structure in which the inside of a unit casing 2 having a generally rectangular parallelepiped box shape is divided into a fan chamber S1 and a machine chamber S2 by a partition plate 28 extending vertically. This outdoor unit 1 is connected to an indoor unit (not shown) provided in an air-conditioned room via refrigerant pipes (not shown). The outdoor unit 1 mainly comprises: the unit casing 2 having a generally rectangular parallelepiped box shape; outdoor fans 4; the refrigerant circuit components 5 that includes devices such as the compressor 51 and the outdoor heat exchanger 52, and valves such as the liquid side shut-off valve 61 and the gas side shut-off valves 62, and constitute a refrigerant circuit. Note that in the description below, unless otherwise specified particularly, terms such as “up,” “down,” “left,” “right,” “front”, “back,” “front side,” and “rear side” indicate the directions when the outdoor unit 1 shown in FIG. 2 is viewed from the front side thereof.

### (2) Structure of the Unit Casing

The unit casing 2 mainly comprises a base plate 21, the top plate 22, the left front plate 23, the right front plate 24, and a right side plate 25.

The base plate 21 is a metallic plate-like member having a horizontally long and generally rectangular shape, which constitutes a base portion of the unit casing 2. The peripheral portion of the base plate 21 is bent upwardly. The outer surface of the base plate 21 is provided with two stationary legs 26 that are fixed on the installation surface at work site. Each of the stationary legs 26 has a generally U-shape in a front view of the unit casing 2, and is a metallic plate-like member which extends from the front side of the unit casing 2 to the rear side thereof.

The top plate 22 is a metallic plate-like member having a horizontally long and generally rectangular shape, which constitutes a top portion of the outdoor unit 1.

The left front plate 23 is a metallic plate-like member that mainly constitutes a left portion of the front side and a left side portion of the unit casing 2, and the lower portion of the left front plate 23 is fixed to the base plate 21 by a screw or the like. The left front plate 23 has an intake port 23a formed therein for air to be drawn into the unit casing 2 by the outdoor fans 4. In addition, the left front plate 23 is provided with discharge ports 23b for blowing out the air drawn inside from the rear side and the left side of the unit casing 2 by the outdoor fans 4. There are two discharge ports 23b formed above and below, each having a fan grille 27 provided thereto.

The right front plate 24 is a metallic plate-like member that mainly constitutes a right portion of the front side and a front portion of the right side of the unit casing 2, and the lower portion of the right front plate 24 is fixed to the base plate 21 by a screw or the like. In addition, the left end portion of the right front plate 24 is fixed to the right end portion of the left front plate 23 by a screw or the like.

The right side plate 25 is a metallic plate-like member that mainly constitutes a rear portion of the right side and a right rear side portion of the unit casing 2, and the lower portion of the right side plate 25 is fixed to the base plate 21 by a screw or the like. Between the back end portion of the left front plate 23 and the rear side end portion of the right side plate 25 in the horizontal direction, there is formed an intake port 23c for air to be drawn into the unit casing 2 by the outdoor fans 4.

Inside this type of unit casing 2 is provided with the partition plate 28 and a tube sheet 29. The partition plate 28 is a vertically extending metallic plate-like member disposed on the base plate 21, and the partition plate 28 is disposed so as to divide the inside of the unit casing 2 into two spaces, i.e., a left space and a right space. In this embodiment, the partition plate 28 has a bent shape so as to protrude toward the fan chamber S1 in a plan view of the unit casing 2. The tube sheet 29 is a metallic plate-like member provided so as to face the right end side of the outdoor heat exchanger 52 having a generally L-shape and disposed so as to extend along the unit casing 2 from the left side to the rear side thereof, and the lower portion of the tube sheet 29 is fixed to the base plate 21 by a screw or the like. The end portion of the tube sheet 29 on the front side of the unit casing 2 and the end portion of the partition plate 28 on the rear side of the unit casing 2 are fixed to each other by a screw or the like. In addition, the right end portion of the left front plate 23 is fixed to the partition plate 28 at the front end portion thereof by a screw or the like. The end portion on the rear side of the right side plate 25 is fixed to the tube sheet 29 at the end portion thereof on the rear side of the unit casing 2 by a screw or the like.

In this way, the inside of the unit casing 2 is divided into the fan chamber S1 and a machine chamber S2 by the partition plate 28. More specifically, the fan chamber S1 is a space surrounded by the base plate 21, the top plate 22, the left front plate 23, and the partition plate 28, and mainly the outdoor fans 4 and the outdoor heat exchanger 52 are disposed therein. The machine chamber S2 is a space surrounded by the base plate 21, the top plate 22, the right front plate 24, the right side plate 25, and the partition plate 28, and mainly the electric equipment assembly 7 and the refrigerant circuit components 5 other than the outdoor heat exchanger 52 are disposed therein. The unit casing 2 is configured such that the inside of the machine chamber S2 will be exposed by removing the right front plate 24. In other words, the right front plate 24 is removed when working on site to perform maintenance and the like of the refrigerant circuit components 5 housed in the machine chamber S2 of the outdoor unit 1.

### (3) Structure of the Outdoor Fan

Each of the outdoor fans 4 is a propeller fan having a plurality of blades and is disposed on the front side of the outdoor heat exchanger 52 in the fan chamber S1. In this embodiment, two outdoor fans 4 are disposed above and below in the fan chamber S1 so as to face the discharge ports 23b. Each of these outdoor fans 4 is configured to be rotatably driven by an outdoor fan electric motor 4a. When the outdoor fans 4 are driven, air is drawn into the inside of the unit casing 2 through the intake ports 23a, 23c on the rear side and the left side of the unit casing 2. After the air passes through the outdoor heat exchanger 52, the air is blown out to the outside of the unit casing 2 from the discharge ports 23b on the front side of the unit casing 2.

### (4) Structure of the Refrigerant Circuit Component

The compressor 51 is a hermetic compressor that houses a compressor electric motor in the housing, and is disposed in the machine chamber S2. In this embodiment, the compressor 51 has a longitudinal cylinder shape whose height is about ⅓ to ½ of the overall height of the unit casing 2, and a lower portion of the compressor 51 is fixed to the base plate 21. In addition, in a plan view of the unit casing 2, the compressor 51 is disposed near in the center of the machine chamber S2 in the front and back direction and also near the partition plate 28 of the machine chamber S2.

The outdoor heat exchanger 52 is disposed in the fan chamber S1. Through the outdoor heat exchanger 52, heat exchange is performed with the air that is drawn into the unit casing 2 by the outdoor fans 4. The outdoor heat exchanger 52 has a generally L-shape in a plan view of the unit casing 2, and is disposed so as to extend along the unit casing 2 from the left side to the rear side thereof.

Inside the unit casing 2, the liquid side shut-off valve 61 and the gas side shut-off valve 62 are disposed, to which refrigerant pipes on the indoor unit side are connected. More specifically, the liquid side shut-off valve 61 and the gas side shut-off valve 62 are disposed at a position facing the right front plate 24 at the front portion of the machine chamber S2. In this embodiment, the liquid side shut-off valve 61 and the gas side shut-off valve 62 are supported by a plate shaped shut-off support member 30 provided so as to extend between the right end portion of the left front plate 23 and the front end portion of the right side plate 25. The shut-off support member 30 is disposed at a height near the upper end of the compressor 51 in the machine chamber S2.

Inside of the unit casing 2 includes the liquid side shut-off valve 61 and the gas side shut-off valve 62, to which refrigerant pipes on the indoor unit side are connected. More specifically, the liquid side shut-off valve 61 and the gas side shut-off valve 62 are disposed at a position facing the right front plate 24 in the front portion of the machine chamber S2. In this embodiment, the liquid side shut-off valve 61 and the gas side shut-off valve 62 are supported by a plate shaped shut-off support member 30 provided so as to extend between the right end portion of the left front plate 23 and the front end portion of the right side plate 25. The shut-off support member 30 is disposed at a height near the upper end of the compressor 51 in the machine chamber S2.

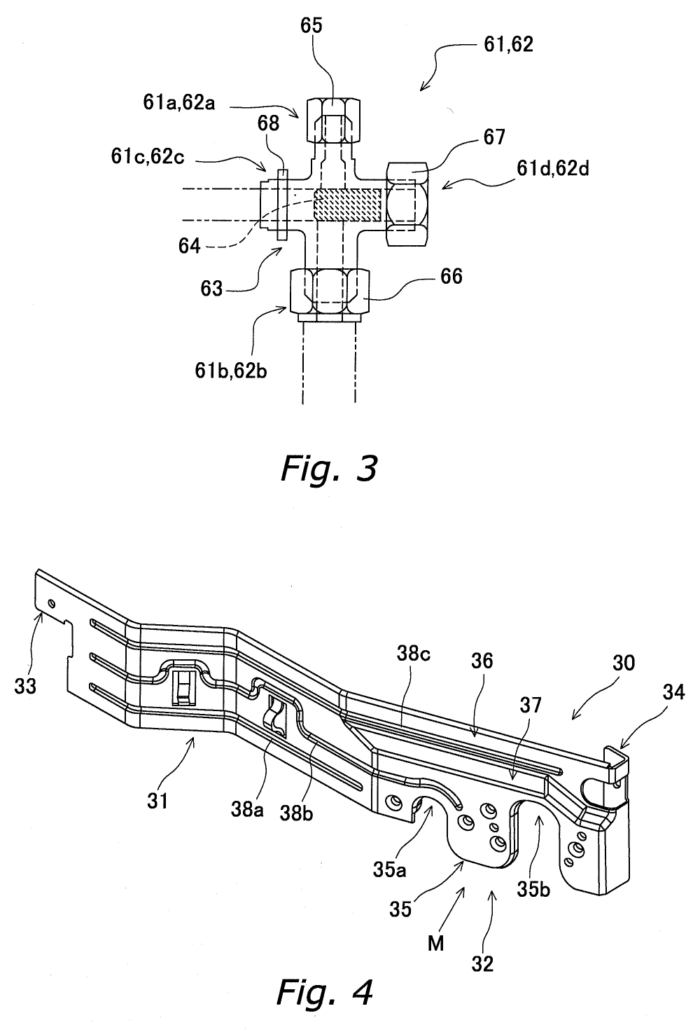

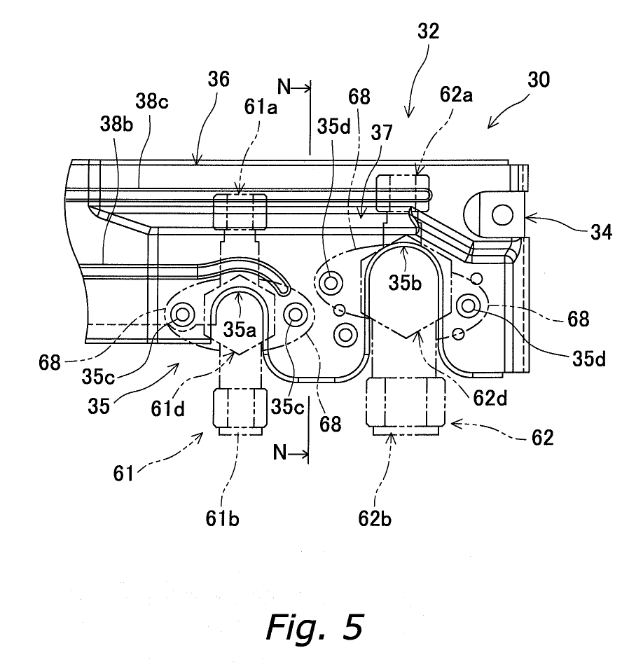

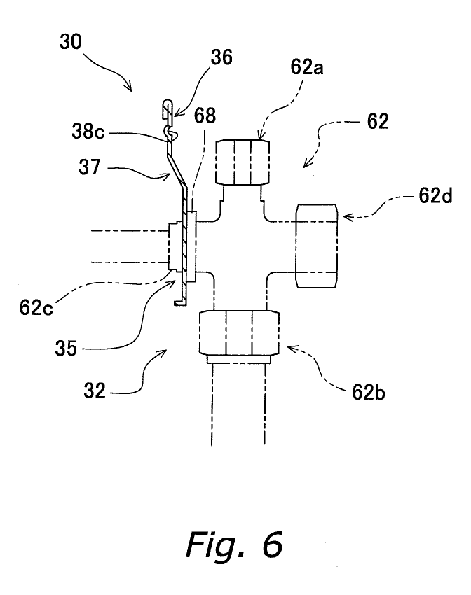

Next, the structures of the shut-off valves 61, 62, and the shut-off valve support member 30 are described in detail with reference to FIGS. 3 to 6. Here, FIG. 3 shows the liquid side shut-off valve 61 and the gas side shut-off valve 62. FIG. 4 is a perspective view showing the shut-off valve support member 30. FIG. 5 is a view taken in a direction of arrow M of FIG. 4. FIG. 6 is a sectional view taken along line N-N of FIG. 5.

The liquid side shut-off valve 61 is a valve having a service port 61a for filling refrigerant, drawing vacuum, and the like. In this embodiment, as shown in FIG. 3, when disposed in the machine chamber S2, the liquid side shut-off valve 61 includes a housing 63 in which a generally cross-shaped internal flow passage extending front and back, up and down is formed. The service port 61a is formed at the upper end of the housing 63; an indoor side connection port 61b connected to a refrigerant pipe on the indoor unit side is formed at the lower end of the housing 63; an outdoor side connection port 61c connected to a refrigerant pipe on the outdoor unit side is formed at the back end of the housing 63; and an operation port 61d is formed at the front end of the housing 63. In addition, near the outdoor side connection port 61c of the housing 63, a flange portion 68 is formed, which is a portion that protrudes to left and right when disposed in the machine chamber S2 and which is fixed to the shut-off valve support member 30. Further, a valve body 64 for opening and closing the passage between the indoor side connection port 61b and the outdoor side connection port 61c is threaded inside the operation port 61d. In addition, a flare nut 65 is threaded into the leading end of the service port 61a, which is usually hermetically sealed. The leading end of the indoor unit side connection port 61b and the refrigerant pipe on the indoor side (shown by the two-dot chain line in FIG. 3) are connected to each other via a flare nut 66. The leading end of the outdoor side connection port 61c and the refrigerant pipe on the outdoor unit side (shown by the two-dot chain line in FIG. 3) are connected to each other by brazing and the like. A flare nut 67 is threaded into the leading end of the operation port 61d, thus the operation port 61d can be opened when opening and closing the valve body 64.

The gas side shut-off valve 62 is a valve having a service port 62a, as is the case with the liquid side shut-off valve 61. In addition, as is the case with the liquid side shut-off valve 61, as shown in FIG. 3, when disposed in the machine chamber S2, the gas side shut-off valve 62 includes a housing 63 in which a generally cross-shaped internal flow passage extending front and back, up and down is formed. The service port 62a is formed at the upper end of the housing 63; an indoor side connection port 62b connected to the refrigerant pipe on the indoor unit side is formed at the lower end of the housing 63; an outdoor side connection port 62c connected to the refrigerant pipe on the outdoor unit side is formed at the back end of the housing 63; and an operation port 62d is formed at the front end of the housing 63. In addition, as is the case with the liquid side shut-off valve 61, near the outdoor side connection port 62c of the housing 63, the flange portion 68 is formed, which is a portion that protrudes to left and right when disposed in the machine chamber S2 and which is fixed to the shut-off valve support member 30. Further, as is the case with the liquid side shut-off valve 61, the valve body 64 for opening and closing the passage between the indoor side connection port 62b and the outdoor side connection port 62c is threaded inside the operation port 62d. In addition, as is the case with the liquid side shut-off valve 61, the flare nut 65 is threaded into the leading end of the service port 62a, which is usually hermetically sealed. As is the case with the liquid side shut-off valve 61, the leading end of the indoor side connection port 62b and the refrigerant pipe on the indoor unit side are connected to each other via the flare nut 66. As is the case with the liquid side shut-off valve 61, the leading end of the outdoor side connection port 62c and the refrigerant pipe on the outdoor unit side are connected to each other by brazing and the like. As is the case with the liquid side shut-off valve 61, the flare nut 67 is threaded into the leading end of the operation port 62d, thus the operation port 62d can be opened when opening and closing the valve body 64.

The shut-off valve support member 30 is an elongated plate shaped member disposed in the machine chamber S2 so as to be extended between the right end portion of the left front plate 23 as a first fixing portion of the outdoor unit 1 and the front end portion of the right side plate 25 as a second fixing portion of the outdoor unit 1. The shut-off valve support member 30 is an integrally formed metallic member mainly comprising a first main body 31, a second main body 32, a first fixed portion 33 and a second fixed portion 34. As used in the following description, the term “longitudinal direction” means the left-and-right direction of the shut-off valve support member 30 when the outdoor unit 1 is viewed from the front thereof; the term “thickness direction” means the front-and-back direction of the shut-off valve support member 30 when the outdoor unit 1 is viewed from the front thereof; and the term “plate width direction” means the up-and-down direction of the shut-off valve support member 30 when the outdoor unit 1 is viewed from the front thereof.

With the shut-off valve support member 30 disposed in the machine chamber S2, the first main body 31 is a portion that extends generally in parallel with the front side of the unit casing 2 (in other words, with the front side of the right front plate 24) from the right end portion of the left front plate 23 toward the right side of the unit casing 2 (in other words, toward the lateral side of the right front plate 24), subsequently, extends inclined in a direction away from the front side of the unit casing 2 (in other words, from the front side of the right front plate 24) toward the right side of the unit casing 2 (in other words, toward the lateral side of the right front plate 24), and subsequently, extends generally in parallel with the front side of the unit casing 2 (in other words, with the front side of the right front plate 24) toward the right side of the unit casing 2 (in other words, toward the lateral side of the right front plate 24). With the shut-off valve support member 30 disposed in the machine chamber S2, the second main body 32 is a portion that extends inclined in a direction away from the front side of the unit casing 2 (in other words, from the front side of the right front plate 24), from the right end in the longitudinal direction of the first main body 31 toward the front end of the right side plate 25. With the shut-off valve support member 30 disposed in the machine chamber S2, a first fixed portion 33 is a portion that extends from the upper left end in the longitudinal direction of the first main body 31 toward the left. The first fixed portion 33 is fixed to the right end portion of the left front plate 23 together with the front end portion of the partition plate 28 by a screw and the like. Note that the first fixed portion 33 may be fixed to the front end portion of the partition plate 28 instead of the right end portion of the left front plate 23. With the shut-off valve support member 30 disposed in the machine chamber S2, the second fixed portion 34 is a portion that first extends rearward from the right end in the longitudinal direction of the second main body 32, and then extends to the left in the longitudinal direction of the same. The second fixed portion 34 is fixed to the front end portion of the right side plate 25 by a screw and the like.

In addition, the second main body 32 mainly comprises an attachment portion 35, an interference prevention portion 36, and a stepped portion 37.

The attachment portion 35 is a portion to which the liquid side shut-off valve 61 and the gas side shut-off valve 62 are attached. The attachment portion 35 is a portion to which the liquid side shut-off valve 61 and the gas side shut-off valve 62 can be attached side by side in the longitudinal direction. In this embodiment, with the shut-off valve support member 30 disposed in the machine chamber S2, the gas side shut-off valve 62 is attached on the side of the right side of the unit casing 2 (in other words, on the side of the lateral side of the right front plate 24), and the liquid side shut-off valve 61 is attached to the left side in the longitudinal direction of the gas side shut-off valve 62. More specifically, with the shut-off valve support member 30 disposed in the machine chamber S2, the shut-off valves 61, 62 are attached to the attachment portion 35 such that the service ports 61a, 62a of the shut-off valves 61, 62, respectively, protrude in the direction perpendicular to the longitudinal direction (here, to the upper side in the plate width direction) (in other words, such that the service ports 61a, 62a protrude from the upper end of the attachment portion 35). In other words, with the shut-off valve support member 30 disposed in the machine chamber S2, the attachment portion 35 has the shut-off valves 61, 62 attached thereto, with the service ports 61a, 62a facing upward and the outdoor side connection ports 61c, 62c of the shut-off valves 61, 62, respectively, penetrating through the back of the shut-off valve support member 30 in the thickness direction. The attachment portion 35 has cutout portions 35a, 35b formed therein for having the outdoor side connection ports 61c, 62c of the shut-off valves 61, 62 penetrate through the shut-off valve support member 30 in the thickness direction. With the shut-off valve support member 30 disposed in the machine chamber S2, the cutout portions 35a, 35b are portions formed by cutting the lower end of the attachment portion 35 in a generally U shape in an upward direction. In addition, screw holes 35c, 35d for threadedly fixing the flange portion 68 of each the shut-off valves 61, 62 are formed at positions where the screw holes 35c and the screw holes 35d respectively sandwich the cutout portions 35a, 35b from both sides in the longitudinal direction of the cutout portions 35a, 35b. Accordingly, with the shut-off valve support member 30 disposed in the machine chamber S2, the indoor side connection ports 61b, 62b of the shut-off valves 61, 62, respectively, protrude outwardly in the opposite direction (here, to the lower side in the plate width direction) from the protruding direction of the service ports 61a, 62a (in other words, the indoor side connection ports 61b, 62b protrude from the lower end of the attachment portion 35), and the operation ports 61d, 62d protrude forward in the thickness direction.

With the shut-off valve support member 30 disposed in the machine chamber S2, the interference prevention portion 36 is located opposite to the attachment portion 35 when viewed in the longitudinal direction (in other words, when viewed from the lateral side of the unit casing 2), away from the service ports 61a, 62a of the shut-off valves 61, 62 in the thickness direction (in other words, a position on the back side of the unit casing 2). The interference prevention portion 36 is a portion disposed so as to overlap with the service ports 61a, 62a when viewed in the thickness direction (in other words, when viewed in the front-back direction of the unit casing 2). The interference prevention portion 36 is generally parallel to the attachment portion 35 when viewed in the longitudinal direction (in other words, when viewed from the lateral side of the unit casing 2). The stepped portion 37 is a portion formed between the attachment portion 35 and the interference prevention portion 36. More specifically, with the shut-off valve support member 30 disposed in the machine chamber S2, the stepped portion 37 is a portion that extends inclined rearward from the upper end of the attachment portion 35 toward the lower end of the interference prevention portion 36. In addition, the interference prevention portion 36 and the stepped portion 37 are formed so as to be continuous across both sides portions of each of the shut-off valves 61, 62 in the longitudinal direction (in other words, both side portions of the service ports 61a, 62a in the longitudinal direction), and further so as to be continuous between the liquid side shut-off valve 61 and the gas side shut-off valve 62 in the longitudinal direction thereof when viewed in the thickness direction. Note that the interference prevention portion 36 and the stepped portion 37 are formed by performing the drawing process to the second main body 32.

In addition, with the shut-off valve support member 30 disposed in the machine chamber S2, the shut-off valve support member 30 has three groove portions 38a, 38b, 38c formed therein, which extend in the longitudinal direction (in other words, in the left-right direction). Each of the groove portions 38a to 38c is formed to be recessed in the thickness direction. More specifically, with the shut-off valve support member 30 disposed in the machine chamber S2, each of the groove portions 38a to 38c has a shape that protrudes toward the back in the thickness direction, in other words, a shape that protrudes in a direction away from the service ports 61a, 62a. With the shut-off valve support member 30 disposed in the machine chamber S2, the groove portion 38a is formed so as to extend over the entire longitudinal direction of the lower portion of the first main body 31. With the shut-off valve support member 30 disposed in the machine chamber S2, the groove portion 38b is formed so as to extend over the entire longitudinal direction of the center portion in the up-and-down direction of the first main body 31, and so as to extend over a portion from the left end of the second main body 32 (specifically, the attachment portion 35) to the left side of the cutout portion 35b across the upper side of the cutout portion 35a. In other words, the groove portion 38b extends in the longitudinal direction so as to overlap with at least a portion of the liquid side shut-off valve 61 when viewed in the thickness direction. With the shut-off valve support member 30 disposed in the machine chamber S2, the groove portion 38c is formed so as to extend over the entire longitudinal direction of the upper portion of the first main body 31, and so as to extend over a portion from the left end of the second main body 32 (specifically, the interference prevention portion 36) to the right end of the cutout portion 35b across the cutout portion 35a. In other words, the groove portion 38c extends in the longitudinal direction so as to overlap with the entirety of the liquid side shut-off valve 61 and at least a portion of the gas side shut-off valve 62 when viewed in the thickness direction.

Further, the upper ends of the first fixed portion 33, the first main body 31, and the second main body 32 are folded downward by a hemming process and the like. In addition, the lower ends of the first main body 31 and the second main body 32 are folded rearward by a hemming process and the like.

(5) Characteristics of the Shut-Off Valve Support Member of the Present Embodiment and the Outdoor Unit Provided with the Same

The shut-off valve support member 30 of the present embodiment and the outdoor unit 1 provided with the same have the following characteristics.

### (A)

With the shut-off valve support member 30 and the outdoor unit 1 provided with the same as described in this embodiment, the interference prevention portion 36 and the stepped portion 37, which connects the space between the attachment portion 35 and the interference prevention portion 36, are formed, thus preventing interference between the shut-off valve support member 30 and the service ports 61a, 62a of the shut-off valves 61, 62, respectively, and increasing the section modulus of the shut-off valve support member 30. Accordingly, it is possible to ensure the operability of the service ports 61a, 62a of the shut-off valves 61, 62, respectively, (for example, operation such as rotating the flare nut 65 and the like) and improve the strength of the shut-off valve support member 30.

Furthermore, since the indoor side connection ports 61b, 62b protrude outwardly from the attachment portion 35 of the shut-off valve support member 30 in the opposite direction (downward direction) from the protruding direction (upward direction) of the service ports 61a, 62a (in other words, the indoor side connection ports 61b, 62b protrude from the lower end of the attachment portion 35), thus improving the operability of the indoor side connection ports 61b, 62b when rotating the flare nut 66. Further, as described above, formation of the interference prevention portion 36 and the stepped portion 37 improve the strength of the shut-off valve support member 30, thus preventing deformation from occurring when rotating the flare nut 66 of the indoor side connection ports 61b, 62b.

### (B)

With the shut-off valve support member 30 of this embodiment, the interference prevention portion 36 and the stepped portion 37 are formed so as to be continuous across the portions on both sides of each of the shut-off valves 61, 62 (specifically, the service ports 61a, 62a) in the longitudinal direction, thus improving the operability and strength of the service ports 61a, 62a of the shut-off valves 61, 62, respectively.

### (C)

With the shut-off valve support member 30 of this embodiment, the interference prevention portion 36 and the stepped portion 37 are formed so as to be continuous between the liquid side shut-off valve 61 and the gas side shut-off valve 62 in the longitudinal direction when viewed in the thickness direction, thus further improving the strength of the shut-off valve support member 30.

### (D)

The shut-off valve support member 30 of this embodiment has the groove portions 38b, 38c formed therein, which extend in the longitudinal direction so as to overlap with at least a portion of the shut-off valves 61, 62 when viewed in the thickness direction, thus further improving the strength of the shut-off valve support member 30.

Further, with the shut-off valve support member 30 disposed in the machine chamber S2, Each of the groove portions 38b, 38c has a shape that protrudes toward the back in the thickness direction, in other words, a shape that protrudes in a direction away from the service ports 61a, 62a, thus preventing a reduction in the operability of the service ports 61a, 62a.

### INDUSTRIAL APPLICABILITY

In a plate shaped shut-off valve support member configured to support a shut-off valve to which a refrigerant pipe on an indoor unit side is connected, and arranged to be extended across a first fixing portion and a second fixing portion of an outdoor unit, utilization of the present invention ensures the operability of a service port of a shut-off valve and improves the strength of the shut-off valve support member.

1. A shut-off valve support member having a plate shape that is configured to support a shut-off valve connected to a refrigerant pipe on an indoor unit side, the shut-off valve support member comprising:
an attachment portion configured to have the shut-off valve attached thereto such that a service port of the shut-off valve protrudes in a direction perpendicular to a longitudinal direction of the shut-off valve support member;
an interference prevention portion located on an opposite side of the attachment portion from the service port in a thickness direction of the shut-off valve support member when viewed in a longitudinal direction of the shut-off valve support member, the interference prevention portion being disposed so as to overlap with the service port when viewed in the thickness direction of the shut-off valve support member; and
a stepped portion connecting the attachment portion and the interference prevention portion.

2. The shut-off valve support member according to claim 1, wherein
the interference prevention portion and the stepped portion are formed so as to be continuous across opposite side portions of the shut-off valve in the longitudinal direction.

3. The shut-off valve support member according to claim 1, wherein
the attachment portion includes longitudinally spaced attachment areas configured to have a liquid side shut-off valve and a gas side shut-off valve attached thereto such that the shut-off valves are attached side by side in the longitudinal direction, and
the interference prevention portion and the stepped portion are formed so as to be continuous with each other between the liquid side shut-off valve and the gas side shut-off valve in the longitudinal direction when viewed in the thickness direction.

4. The shut-off valve support member according to claim 1, wherein
the shut-off valve support member has a groove portion formed therein that is recessed in the thickness direction, the groove portion extending in the longitudinal direction so as to overlap with at least a part of the shut-off valve when viewed in the thickness direction.

5. An outdoor unit of an air conditioner including the shut-off valve support member of claim 1, the outdoor unit further comprising:
a casing having a generally rectangular parallelepiped box shape;
a partition plate extending vertically so as to divide the inside of the casing; and
a shut-off valve supported by the shut-off valve support member with a refrigerant pipe on an indoor unit side being connected to the shut-off valve,
the shut-off valve support member extending between a first fixing portion and a second fixing portion, the first fixing portion being formed on the partition plate or on a surface of the casing near the partition plate and the second fixing portion being formed on a surface of the casing facing the partition plate.

6. The outdoor unit according to claim 5, wherein
the interference prevention portion and the stepped portion are formed so as to be continuous across opposite side portions of the shut-off valve in the longitudinal direction.

7. The outdoor unit according to claim 5, wherein
the attachment portion includes a pair of longitudinally spaced attachment areas with the shut-off valve attached to one of the attachment areas as a liquid side shut-off valve and an additional shut-off valve attached to the other of the attachment areas as a gas side shut-off valve such that the shut-off valves are attached side by side in the longitudinal direction, and
the interference prevention portion and the stepped portion are formed so as to be continuous with each other between the liquid side shut-off valve and the gas side shut-off valve in the longitudinal direction when viewed in the thickness direction.

8. The outdoor unit according to claim 5, wherein
the shut-off valve support member has a groove portion formed therein that is recessed in the thickness direction, the groove portion extending in the longitudinal direction so as to overlap with at least a part of the shut-off valve when viewed in the thickness direction.

9. The outdoor unit according to claim 6, wherein
the attachment portion includes a pair of longitudinally spaced attachment areas with the shut-off valve attached to one of the attachment areas as a liquid side shut-off valve and an additional shut-off valve attached to the other of the attachment areas as a gas side shut-off valve such that the shut-off valves are attached side by side in the longitudinal direction, and
the interference prevention portion and the stepped portion are formed so as to be continuous with each other between the liquid side shut-off valve and the gas side shut-off valve in the longitudinal direction when viewed in the thickness direction.

10. The outdoor unit according to claim 9, wherein
the shut-off valve support member has a groove portion formed therein that is recessed in the thickness direction, the groove portion extending in the longitudinal direction so as to overlap with at least a part of the shut-off valve when viewed in the thickness direction.

11. The shut-off valve support member according to claim 2, wherein
the attachment portion includes longitudinally spaced attachment areas configured to have a liquid side shut-off valve and a gas side shut-off valve attached thereto such that the shut-off valves are attached side by side in the longitudinal direction, and
the interference prevention portion and the stepped portion are formed so as to be continuous with each other between the liquid side shut-off valve and the gas side shut-off valve in the longitudinal direction when viewed in the thickness direction.

12. The shut-off valve support member according to claim 11, wherein
the shut-off valve support member has a groove portion formed therein that is recessed in the thickness direction, the groove portion extending in the longitudinal direction so as to overlap with at least a part of the shut-off valve when viewed in the thickness direction.
